(19) United States
(12) Patent Application Publication
(10) Pub. No.: US 2008/0220929 A1
(43) Pub. Date: Sep. 11, 2008

(54) Engine-Driven Vehicle Having a Gear Mechanism for an Auxiliary Unit, in Particular as a Planetary Gear Set for Integration Into the Drive of the Auxiliary Unit, and Corresponding Gear Mechanism

(75) Inventors: Jens Gebhardt, Bernsbach (DE); Andre Gopfert, Waldenburg (DE); Dominik Zschocke, Chemnitz (DE)

Correspondence Address: Steinfl & Bruno, 301 N Lake Ave Ste 810, Pasadena, CA, 91101, US

(73) Assignee: MBM Technologie GMBH, St. Egidien (DE)

(21) Appl. No.: 12/089,702

(22) PCT Filed: Oct. 10, 2006
(86) PCT No.: PCT/EP06/67224

§ 371 Date: Apr. 9, 2008

(30) Foreign Application Priority Data
Oct. 11, 2005 (DE) 10 2005 049 366

(51) Int. Cl. F16H 3/54

(52) U.S. Cl. 475/331

(57) ABSTRACT

The present invention relates to a gear mechanism, in particular to a planetary gear set, which can be used in a motor vehicle in order to make it possible, in an advantageous way in terms of energy, to drive auxiliary units of the motor vehicle from the main drive device in a speed-adapted and therefore power-adapted manner.

The present invention relates to an engine-driven vehicle with a main drive device, with an auxiliary drive device for an auxiliary unit, wherein the main drive device is coupled to the auxiliary drive device and transmits power generated on the main drive device to the auxiliary drive device.

Such engine-driven vehicles are known from the general prior art. These can be land, air or water vehicles which are driven with, any main drive device for example a combustion engine, an electric motor or the like. Such engine-driven vehicles comprise auxiliary units which likewise have to be driven via an auxiliary drive device. Such auxiliary units are for example a power steering pump, an air-conditioning compressor, a fan or the like.

The auxiliary drive device in such engine-driven vehicles is regularly driven by an output shaft of the main drive device.

Because of increasing rated outputs, auxiliary units in engine-driven vehicles require correspondingly increased drive power. This results in increased energy consumption and in the case of combustion engines also in increased total pollutant emission of the engine-driven vehicle. Also a reason for increased energy consumption and increased pollutant emission is that the auxiliary units are dependent on the operation of the main drive, i.e. are driven by said main drive irrespective of whether the auxiliary unit concerned happens to be in need of power or not.

If the auxiliary unit for example is a power steering pump it has to provide the maximum power at low speeds since rapid steering movements with large steering angles are only required then. Low speed however also means low engine rotational speed and thus a low drive rotational speed of the power steering pump in the auxiliary drive. For this reason the power steering pump must be dimensioned so that it is of a sufficiently large nominal size in order to be able to make available satisfactory steering assistance even at a low drive rotational speed.

If the auxiliary unit is an air-conditioning compressor it is generally only operated at idle speed after the engine is started until the vehicle is driven off and even while driving said air-conditioning compressor has no permanently increased rotational speed at its disposal because of shifting operations and vehicle stoppage with idle speed. If maximum output happens to be demanded for example following a prolonged stoppage phase with solar radiation this compressor must be designed so that the rated output is achieved even at low rotational speeds. During subsequent driving with higher engine rotational speeds merely a considerably reduced cooling output is utilized once the vehicle interior has cooled down.

The two aforementioned examples of auxiliary units thus show a less than optimal adaptation of power demand and power output or rotational speed, demand and rotational speed availability.

Earlier examples are already known from the patent literature in which it was attempted, through additional gear mechanisms for auxiliary units which were driven from the main drive device such as the crankshaft or an output device connected with the crankshaft such as a belt pulley, to operate the auxiliary unit with rotational speeds that were modified compared to the main drive device. Here, measures are more preferably known which operate with different transmission ratios as a function of an additional parameter.

DE 36 22 335 A1 shows a planetary gear set attached to the camshaft which can be shifted backwards and forwards between a transmission ratio of 1:1 and a transmission ratio of 1:3 through a braking device to be engaged. According to the description a mean rotational speed range between approximately 700-1000 rpm and 2'000-2400 rpm is to be raised. Although the planetary gear set operates with a hysteresis, it only offers two rotational speeds that can be alternately selected. The gear mechanism thus provides no multi-stage shifting capability. In addition, the only figure of DE 36 22 335 A, which represents the gear mechanism proper, shows the planetary gears whose teeth are engaged with sun gear and ring, gear, wherein the output shaft is embodied similar to a ring gear.

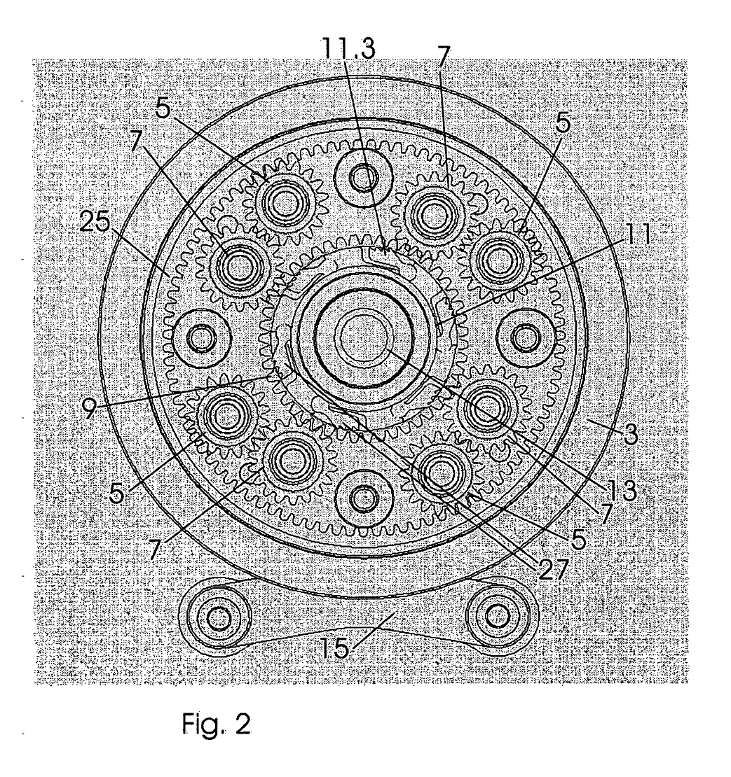

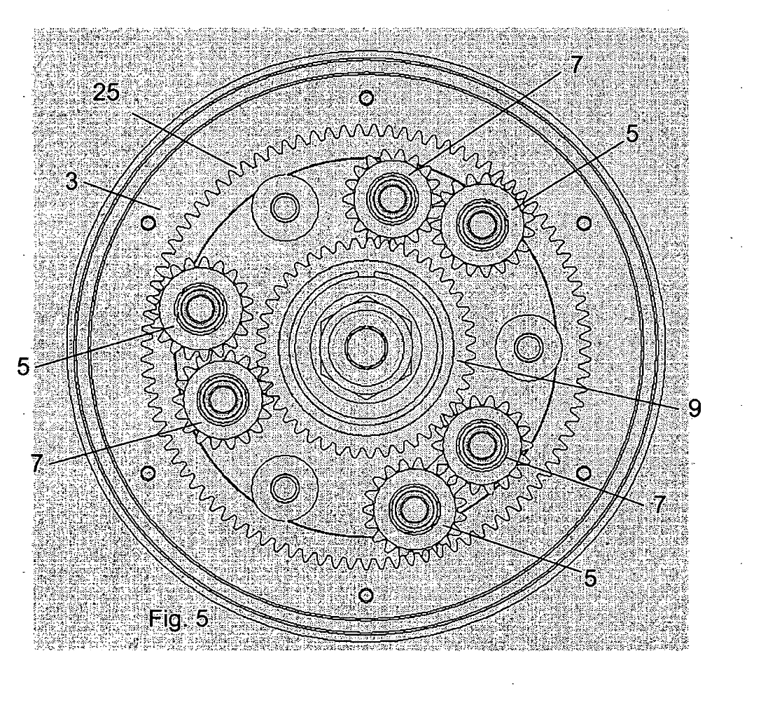

GB 20 22 202 A describes two exemplary embodiments, shown in FIGS. 2 and 5, of a temperature-dependent fan drive which differ in their controls. In GB 20 22 202 A, too, only a single planetary gear can be seen whose teeth are engaged with sun gear and ring gear, wherein the output shaft is embodied similar to a ring gear.

The object of the present invention therefore is to further embody an engine-driven vehicle of the type mentioned at the outset that the rigid coupling of an auxiliary unit to the rotational speed of the main drive device is omitted in an advantageous manner in that with the building space available in the auxiliary drive a solution is looked for which in terms of energy can be advantageously integrated. Furthermore the object consists in creating a corresponding gear unit which can also be installed in a motor vehicle of today's type.

According to the invention the object is solved in that a gear mechanism that can be shifted without interruption in multiple stages is arranged, between the auxiliary drive device and the auxiliary unit. The gear mechanism is characterized by the features of the corresponding independent claim.

With the arrangement of a gear mechanism that can be shifted without interruption in multiple stages between the auxiliary drives device and the auxiliary unit it is possible to save a lot of energy. With combustion engines the fuel saving could be around 0.5 to 1.0 litre/100 km. The overall pollutant emission with combustion engines is also lowered accordingly.

A further advantage according to the present invention must be seen in that the gear mechanism comprises a ring gear via which the drive is effected. In addition to this it is an advantage that the gear mechanism also comprises a sun gear, an internal planetary gear and an external planetary gear. With these components the gear mechanism can be embodied as a planetary gear set and configured in such a way that in an advantageous manner it provides step-up transmission while maintaining the direction of rotation. The possibility of step-up transmission with absent or low load permits the operation of the auxiliary unit favourable in terms of energy with minimum rotational speed with identical rotational speed transmission. If power is demanded it is possible to change to step-up transmission without interruption in a jumping function so that the demanded power is available adequately spontaneously.

A further advantage consists in that the gear mechanism has several operating modes of which at least one first operating mode can be shifted externally actuated.

A further advantage consists in that a second operating mode stops the auxiliary unit. In addition to this it is also advantageous that the operating modes comprise three switching stages. In this preferred advantageous embodiment the first switching stage results in stopping (i=0), the second switching stage in identical rotational speed transmission (i=1) and the third switching stage in step-up transmission or step-down transmission (i≠1).

Finally it is of advantage that the ring gear is driven through a pulling means such as for example a belt. To this end the ring gear in an advantageous manner is to be designed as internally toothed belt pulley. With these features it is possible to integrate the gear mechanism into the belt drive for an auxiliary unit.

Various embodiments of the present invention are described in more detail in the following by means of the drawings. It shows:

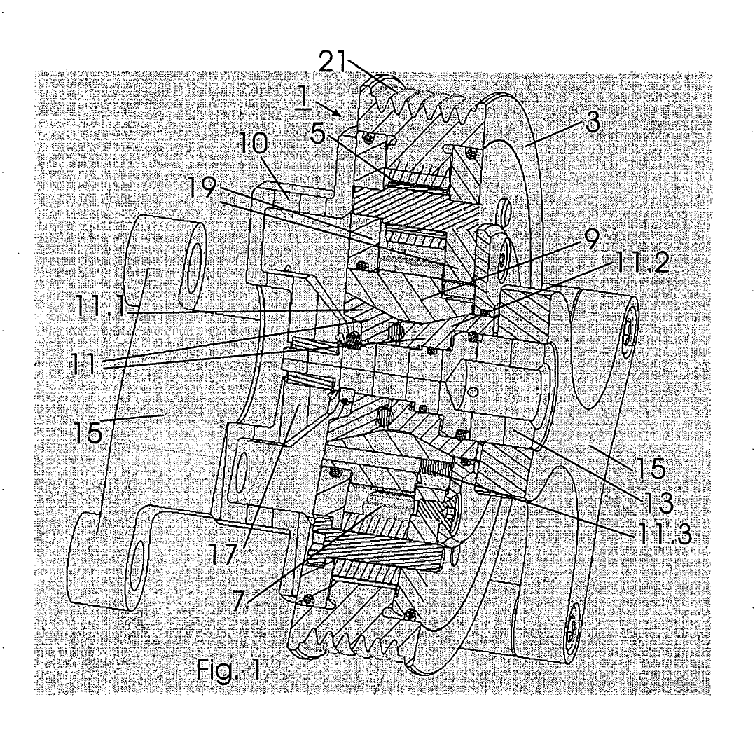

FIG. 1 a schematic perspective view of a gear mechanism designed as planetary gear set according to the present invention for use in an engine-driven vehicle;

FIG. 2 a schematic lateral view of the planetary gear set from FIG. 1;

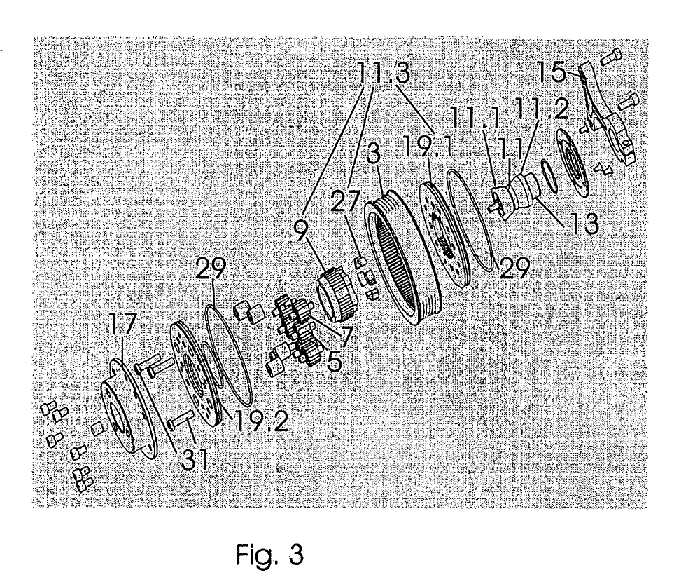

FIG. 3 a schematic exploded view of the planetary gear set from FIG. 1;

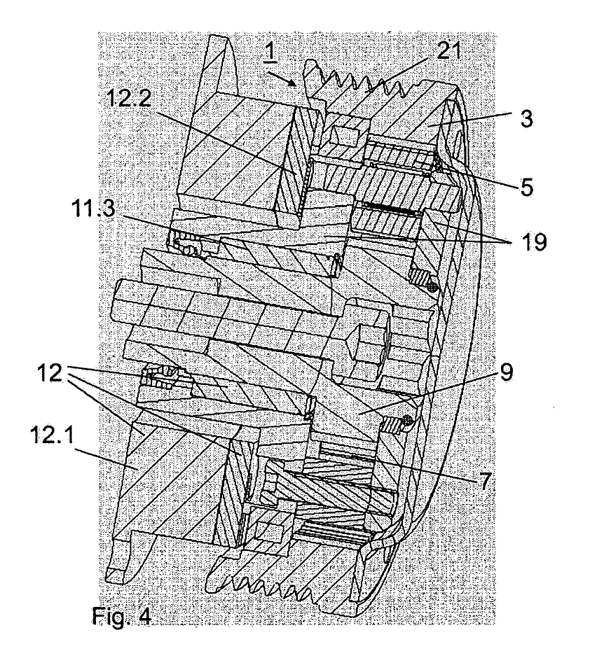

FIG. 4 a schematic, perspective view of a further embodiment of a gear mechanism designed as planetary gear set according to the present invention for use in an engine-driven vehicle;

FIG. 5 a schematic lateral view of the planetary gear set from FIG. 4;

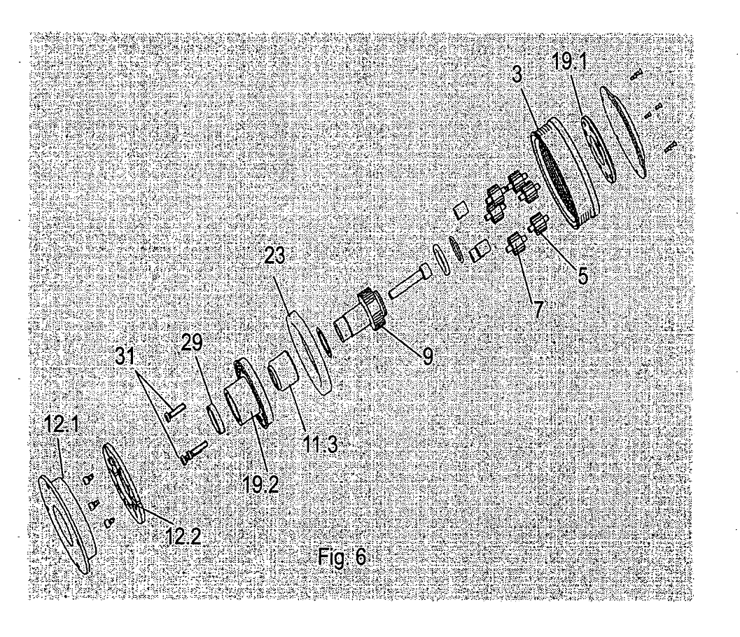

FIG. 6 a schematic exploded representation of the planetary gear set from FIG. 4;

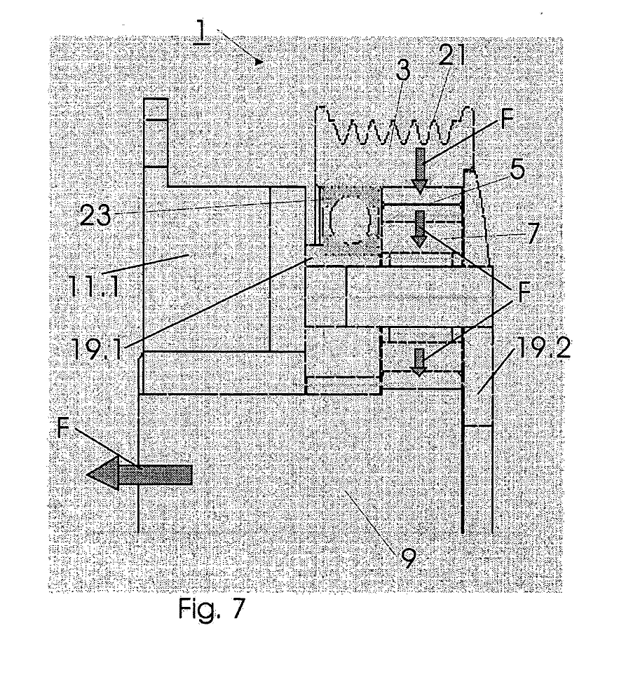

FIG. 7 a sectional view of a further exemplary embodiment of a planetary gear set according to the invention;

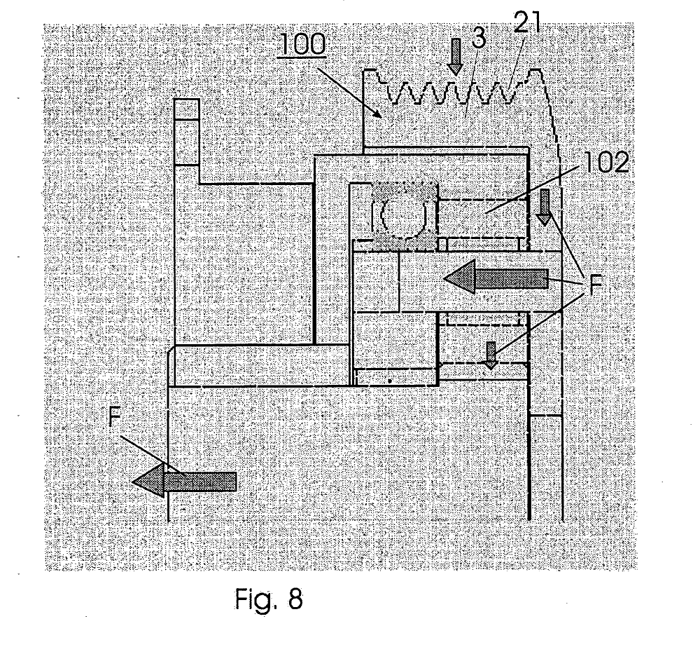

FIG. 8 a force flow with deflections which is more disadvantageous compared with FIG. 7; and

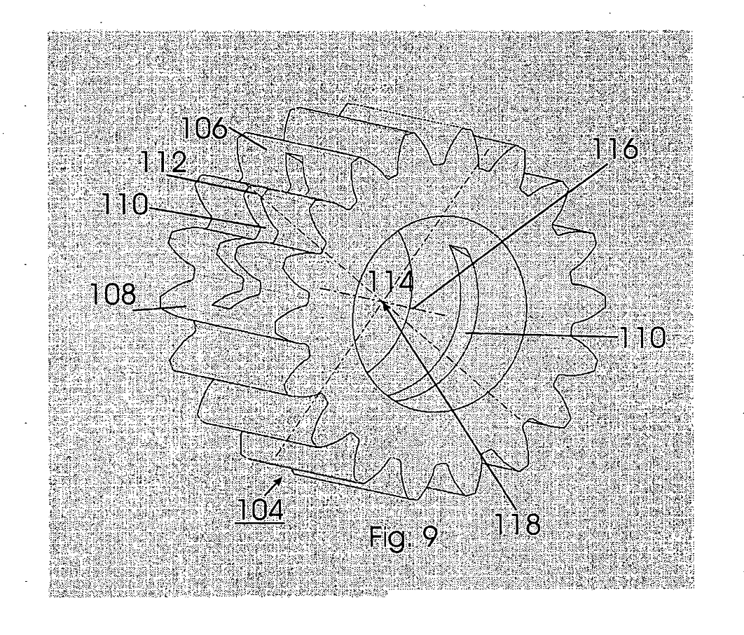

FIG. 9 a suitable planetary gear of a similar embodiment according to FIG. 1 to 3 or according to FIG. 4 to 6 or according to FIG. 7.

Similar parts have been designated with the same reference symbols although in some aspects, which are not so essential to the understanding, they may differ from one another.

FIG. 1 schematically shows a perspective representation of a gear mechanism 1 for installation in an engine-driven vehicle according to Claim 1 in partial section. The gear mechanism 1 in the present embodiment is designed as planetary gear set. The gear mechanism 1 comprises a ring gear 3. Which in the present embodiment, is designed as internally toothed belt pulley. The ring gear 3 is engaged with an outer planetary gear 5. The outer planetary gear 5 is engaged with an inner planetary gear 7. The inner planetary gear 7 is engaged with a sun gear 9. The sun gear encloses a coupling device 11 which in the present embodiment is designed as a cone coupling and comprises the coupling part 11.1 and a second coupling part 11.2.

In addition, the coupling device 11 also comprises a freewheeling coupling 11.3. The first coupling part 11.1 and the second coupling part 11.2 are seated on a coupling carrier 13. The coupling carrier 13 is mounted on a torque support 15 and on an adapter 17. Via the adapter 17, the gear mechanism 1 is mounted in the vicinity of the relevant auxiliary unit or in the vicinity of the relevant auxiliary drive device in such a manner that it is integrated in the auxiliary drive of the auxiliary unit. A planet carrier device 19 is split into a first planet carrier 19.1 and 19.2 and serves for the guidance and mounting of the planetary gears 5,7 and for the introduction and discharge of the torque.

FIG. 3 is a schematic exploded view of the gear mechanism from FIG. 1. On the torque support 15 the components described with, reference to FIG. 1 are arranged: the first coupling part 11.1, the first, right planet carrier 19.1, the coupling carrier 13, the ring gear 3, the freewheeling coupling 11.3, the sun gear 9, the inner planetary gears 7 and the outer planetary gears 5, the second coupling part 11.2, the second, left planet carrier 19.2, the adapter 17.

Accordingly, the gear mechanism 1 substantially comprises a ring gear 3 as well as a or a plurality of outer planetary gears 5 permanently engaged with said ring gear and inner planetary gears 7 in turn permanently engaged with said outer planetary gears, which inner planetary gears are engaged with the concentrically arranged sun gear 9, wherein the drive is effected via the ring gear 3.

In a preferred embodiment the gear mechanism has several operating modes, wherein three operating modes correspond to three shifting positions, namely a first shifting stage, which brings about stoppage or complete decoupling, a second shifting stage, which brings about identical rotational speed transmission (i=1) and a third shifting stage which brings about step-up operation or step-down operation (i≠1).

The shifting positions can be triggered either self-actuated and/or based, on the direction of rotation or externally actuated, as for example hydraulically or electromechanically or in combination of the mentioned methods.

The gear mechanism 1 that can be shifted without interruption in multiple stages can comprise kinematics with fail-safe characteristics, so that upon failure of the actuator the gear mechanism 1 spontaneously returns to (i=1).

The arrangement according to the invention allows the operation of the auxiliary unit with a rotational speed adapted, compared with the rigid coupling, to the rotational speed of a crankshaft, so that even with reduced size of the auxiliary unit said auxiliary unit is able to provide the same output in the design point. Step-up transmission, of the gear mechanism 1 that can be shifted without interruption in multiple stages with the value (i=x) allows an increase of the rotational speed of the auxiliary unit by the factor x and allows a reduction of the specific displacement volume of the unit to the value 1/x.

Upon a change to operation with i=1 the energy consumption of the respective auxiliary unit is reduced because of the reduced power consumption resulting from the reduced size.

Through the arrangement according to the invention the output, of the associated gear mechanism 1 shiftable free of interruptions in multiple stages or planetary gear set and the auxiliary unit with absent or low load at i=1 with low rotational speeds and optimum efficiency, low wear and minimum noise. Accordingly, the rated quantities and thus the power consumption of the power steering pump described as an example and the air-conditioning compressor described as an example can be reduced to 1/x. Thus, considerable savings potentials both on the investment side with the costs of the units as well as with the operating costs through lower fuel consumption because of the reduced total power consumption are achieved. At the same time, the pollutant balance is improved and the power available to drive the vehicle is increased.

Two states are exemplarily described (in a first embodiment):

State I. (Transmission ratio 1:1)
Drive via belt pulley
Output via planet carrier
Cone coupling open
Freewheeling coupling engaged
   Two gear elements are rigidly connected, which means the gear mechanism 1 circulates as a block

State II. (Transmission ratio 1:x)
Drive via belt pulley
Output via planet carrier
Cone coupling closed.
Freewheeling coupling in overrun mode
   Sun gear stationary, which means gear mechanism in step-up transmission

FIG. 4 schematically shows a perspective representation of a gear mechanism 2 for installation in an engine-driven vehicle according to Claim 1 in partial section. The gear mechanism operates according to the inventive principle of the subordinate claim. The gear mechanism 2 in the present embodiment is designed as planetary gear set. The gear mechanism 2 comprises a ring gear 3, which in the present embodiment is designed as internally toothed belt pulley. The ring gear 3 is engaged with an outer planetary gear 5. The outer planetary gear 5 is engaged with an inner planetary gear 7. The inner planetary gear 7 is engaged with a sun gear 9. The planetary gears are connected with the planet carrier 19. A shifting device 12 is adapted to the planet carrier which in the present embodiment is designed as electromagnetic brake and comprises the braking element 12.1 and a second braking element 12.2.

In addition to this, the shifting device 12 also comprises a freewheeling coupling 11.3. The first braking element 12.1 is connected in a rotationally fixed, manner with the housing of the respective auxiliary unit and thus establishes the support of the torque in the shifted mode. The second braking element 12.2 is connected with the planet carrier 19. This planet carrier 19 is divided into a first planet carrier 19.1 and 19.2 and serves for the guiding and accommodating of the planetary gears 5, 7 and to introduce, or discharge the moment, more preferably a rotational or braking moment. Via the sun 9 the gear mechanism, 2 is mounted in a suitable manner in the vicinity of the corresponding auxiliary unit or in the vicinity of the corresponding auxiliary drive device in such a manner that said gear mechanism is integrated in the auxiliary drive, of the auxiliary unit.

FIG. 6 schematically shows an exploded representation of the gear mechanism 2 from FIG. 4. The components described with reference to FIG. 4 are arranged about the sun 9 the first braking element 12.1, the first, right planet carrier 19.1, the ring gear 3, the freewheeling coupling 11.3, the sealed bearing 23, the inner planetary gears 7 and the outer planetary gears 5, the second braking element 12.2, the second, left planet carrier 19.2, the clamping screws 31.

The gear mechanism 2 thus substantially comprises a ring gear 3 as well as 1 or a plurality of outer planetary gears 5 permanently engaged with said ring gear and inner planetary gears 7 which in turn are permanently engaged with said ring gear, which are engaged with the concentrically arranged sun gear 9 wherein the drive is effected via the ring gear 3.

Triggering the shifting positions between the shifting modes can either take place self actuated and/or dependent on the direction of rotation or externally actuated, such as for example hydraulically, pneumatically or electromechanically or in a combination of the mentioned methods.

When changing to the operation with i=1 the energy consumption of the respective auxiliary unit is reduced because of the reduced power consumption which results from the reduced size.

Through the arrangement according to the invention the output of the associated gear mechanism 2 shiftable without interruption in multiple stages or planetary gear set and the auxiliary unit with absent or low load at i=1 run with low rotational speeds and optimal efficiency of 100% without wear and noise. Accordingly, the rated quantities and thus the power consumption of the power steering pump described as an example and of the air-conditioning compressor described as an example can be reduced to 1/x. Thus considerable savings potentials both on the investment side with the costs of the units as well as with the operating costs through lower fuel consumption because of the reduced overall power consumption are achieved. At the same time the pollutant balance is improved and the power available to drive the vehicle increased.

Exemplarily two states are described (in a second embodiment):

State I: (Transmission ratio 1:1)
Drive via belt pulley
Output via sun
Brake open
Freewheeling coupling engaged

Two gear elements are rigidly connected, i.e. the gear mechanism 2 circulates as a block.

State II. (Transmission ratio 1:x)
Drive via belt pulley
Output via sun
Brake closed
Freewheeling coupling in overrun mode

Planet carrier is stationary, i.e. the gear mechanism is in step-up mode.

The planet carrier device 19 according to the exemplary embodiments of FIGS. 4 to 6 is clamped through clamping screws 31, which extend from the right planet carrier 19.1 to the left planet carrier 19.2, as planet carrier clamping screws. The gear sets of the planetary gear set, which always occur in pairs, are located between the planet carrier devices. The ring gear 3 is driven from the drive shaft rigidly coupled, to the rotational speed via its running surface 21 preferentially shrunk-on in the case of a belt drive through a drive (not shown) such as for example a chain or a belt. The planetary step-up gear mechanism 2 arranged within the ring gear 3, in a space-saving manner through the internal arrangement in the annulus about the output, transmits the rotational speed to the component of the auxiliary unit (not shown) connected to the drive. A suitable transmission for many auxiliary units is a step-up transmission. As already explained at the outset, for example in the case of an auxiliary unit power steering pump, more than 99.8% of the running power of the pump has to be applied to operations during which the gear mechanism circulates as a block free of loss. The long-term measurement of 99.8% has been obtained with an embodiment that was determined with a pump that was constructed with half the specific delivery volume compared with a pump without gear mechanism. In only 0.2% of the operating conditions or the operating time is a step-up drive by the factor 2 required. Other auxiliary units show similarly dramatic maladaptations so that a rotational speed adaptation substantially contributes to the increase of efficiency. From the ring gear 3 with its internal teeth 25 the rotation, preferentially circulating as a block loss-free, is transmitted to the sun gear 9 via two planetary gears 5, 7, each which occur multiply, e.g. in triplicate or quadruplicate. The shifting device 12 with a freewheeling coupling 11.3 ensures the equally oriented direction of rotation between drive and output of the planetary gear set arranged in the ring gear 3 with opened brake in order to enable synchronous circulation as a, block. While with desired transmission ratios of i≠1, e.g. in low rotational speed ranges of the combustion engine, the brake is briskly closed by the shifting device 12 and the freewheeling coupling 11.3 overruns without unloading. By means of the brake, which consists of the braking, elements 12.1 and 12.2, the planet carrier 19 is connected with the housing of the auxiliary unit (not graphically represented) and the transmission ratio i≠1 activated. The planetary gears 5, 7 are in mesh with each other. The inner planetary gear 7 transmits the drive power to the sun gear 9. The outer planetary gear 5 is driven through the internal teeth 25 of the ring gear 3.

FIGS. 2 and 5 each show a sectional view through two different embodiments of the invention according to the FIGS. 1 and 4. The planetary gears 5, 7, the sun gear 9, the ring gear 3 with its internal teeth 25 look like a double-constructed planetary system from a lateral perspective, wherein the two inter-meshing planetary gears 5,7, offset relative to each other both in circumferential direction and also in the direction towards the centre, can transmit the power from the outside to the inside without additional deviations. To understand the remaining reference symbols shown, reference is made to the explanations relating to the FIGS. 1, 3, 4 and 6.

Although it is crowded in ring gears 3 according to the invention, for example a ring gear 3 for a power steering pump has an outer diameter of approximately 100 mm to 130 mm and for example a ring gear 3 for a compressor, more preferably an air-conditioning compressor, has an outer diameter of approximately 90 mm to 135 mm, according to an aspect an auxiliary unit gear mechanism according to the invention is equipped with two intermeshing planetary gears each, for in this way a step-up transmission ratio with a spread of just under 6 up to values of more than 1.5, e.g. 1.7 can be generated. The transmission maintains the direction of rotation between driven belt pulley and sun gear. Teeth numbers of approximately 100 teeth for the internal toothing 25 of the ring gear 3 have proved favourable in tests, which means a tooth division of the internal toothing of 1.8° over the internal circumference, while the sun gear 9 comprises 17 or 60 teeth for example. The gear space enclosed by the seal 29 (see FIG. 3 and FIG. 6) and the sealed bearing 23, in which the gears are located, is protected from dirt entering the space and lubricants being lost from the space.

A further aspect of the present invention can be taken from FIG. 7 compared with FIG. 8. FIG. 7 shows how the force or moment flow (F) is to be realised in a planetary gear set according to the invention. The force flow (F) occurs in the same plane from the outside to the inside. Only the force-discharging speed-adapted element, e.g. the sun gear 9, is subjected to a force deflection and concomitant moment deflection. The remaining tooth transmissions between ring gear 3 of the gear mechanism 2 to the outer planetary gears 5 on the one hand, the outer planetary gears 5 to the inner planetary gears 7 on the other hand and from the inner planetary gears 7 to the sun gear 9 as third transmission are subjected to an equally directed force transmission, i.e. each force transmission from one gear to the next gear from the outside to the inside is present in the same plane which is parallel to the planet carrier device 19.1 and 19.2, wherein only the transmission ratios determine the rotational speed, the forces and the moment. An auxiliary unit drive according to the invention directly coupled via a mechanical drive means, fed from the main engine drive, has a force transmission in identical direction which runs from the outside to the inside. The gear mechanism 2 according to the invention in the transmission range of the ring gear 3, the annulus segment arranged about the sun gear 9, is free of moment deflection. The gear mechanism 2 according to the invention according to the FIGS. 4 to 7 can thus be realised with lower load, more stability over the long term, with less wear in a wider spread range of the transmission ratio compared with a gear mechanism 100 according to FIG. 8, which likewise is to be formed below a ring, gear 3 with its running surface 21, than the examples from the prior art cited above. In contrast with the previously published approaches with one planetary gear 102 the special application cases in the automotive auxiliary unit drive with transmissions from 2 to approximately 5, 9 with mechanical coupling can now be realised in the motor car ready for series production with a gear mechanism 1 or 2 according to the invention.

According to an inventive aspect a planetary gear set according to the invention consists of the three dominant main components of ring gear, planet carrier and sun gear. The contours of all three elements can be described in an abstract manner and fundamentally considered geometrically as simple hollow cylinders. As is evident from FIGS. 7 and 8 the hollow cylinder elements can be produced free of pre-mounting without, additional plates. The main components of ring gear 3, planet carrier 19 and sun gear 3 are simple geometrical figures which (in the mathematical sense) can be continuously (technologically practical) as a turned part. They are round bodies, which need not be followed by any termination surfaces. In contrast with this, moment-transmitting ring-shaped plates have to, be additionally attached to the hollow cylinders in the case of the gear mechanisms usual to date, since the torque has to be directed about at least one gear element. As a result, the space required by the planetary gear set according to the invention both in axial as well as in radial direction is significantly less than with the known gear mechanisms. The superficial disadvantage of using two planetary gears instead of one is more than significantly compensated for by these indirect measures. At the same time, the manufacturing methods are drastically, simplified which is not least reflected also in the manufacturing costs.

Activation between the modes can, according to different exemplary embodiments which are not shown, be demand-controlled or rotational speed-controlled. The actuating system for the mode adjustment can be connected to an electronic system such as an engine control unit with suitable measuring sensors such as angular velocity measuring instrument, revolution counter, power-measuring instrument. With the electronic system a control for the gear mechanism can also be established according to known methods. Valves can also control the auxiliary media such as air or oil which serve the actuation system.

FIG. 9 shows a detail which in each of the exemplary embodiments shown can be implemented as first planetary gear 5 or as second planetary gear 7. During tests with planetary gear sets according to the invention in the auxiliary unit train of motor vehicle engines at greater percentage step-up times (e.g. 50% step-up component (i≠1) with an air-conditioning compressor compared to 50% with (i=1) it has been shown that the oil lubrication of the planetary gear set filled with gear oil is substantial. The oil mist created in the gear mechanism is used to lubricate the planetary gear bearings. To this end, one or a plurality of slots 110, to be utilised as lubricating slots, are provided in a planetary gear 105 which is used in place of the previously described planetary gears 5,7. The respective slot 110 is limited in its length. The slot 110 divides some teeth of the planetary gear 104. The slot 110 runs from a first tooth 106 to a second tooth 108, wherein both teeth 106, 108 need not be adjacent to each other. The slot 110 preferentially is located in the middle of the width of the planetary gear 104. The middle 112 of the slot 110 then almost or actually coincides with the middle 114 of the gear 104. In order to be able to have the planetary gear 104, which according to an exemplary embodiment rotates with rotational, speeds between 10,000 and 40,000 revolutions/min., preferentially 20,000 revolutions/min., run unbalance-free, the slot 110 is attached in the gear 104 so that the recessed material does not create any off-centre load. The gear 104 is unbalance-free, it is balanced in terms of weight. Thus, according to an exemplary embodiment 2 or 3 slots which are identical in type and which preferentially run at a middle height in longitudinal direction and cut individual teeth are provided in circumferential direction. In this case the centre of gravity 118 of the planetary gear 104 coincides with the axis 116 of the planetary gear 104. The centre of gravity 118 of the planetary gear 104 is in the middle in the interior of the planetary gear 104.

### LIST OF REFERENCE SYMBOLS

| Reference | |
|---|---|
| symbol | Name |
| 1 | Gear mechanism, more preferably according to a first |
| | exemplary embodiment |
| 2 | Gear mechanism, more preferably according to a second |
| | exemplary embodiment |
| 3 | Ring gear |
| 5 | Planetary gear, more preferably outer planetary gear |
| 7 | Planetary gear, more preferably inner planetary gear |
| 9 | Sun gear |
| 11 | Coupling device |
| 11.1 | Coupling part |
| 11.2 | Coupling part |
| 11.3 | Freewheel coupling |
| 12 | Shifting device |
| 12.1 | Braking element |
| 12.2 | Braking element |
| 13 | Coupling carrier |
| 15 | Torque support |
| 17 | Adapter |
| 19 | Planet carrier device |
| 19.1 | First planet carrier, more preferably right planet carrier |
| 19.2 | Second planet carrier, more preferably left planet carrier |
| 21 | Running surface, more preferably belt running surface |
| | vulcanised on |
| 23 | Ball bearing |
| 25 | Ring gear internal toothing |
| 27 | Freewheel transmission element, more preferably |
| | engagement element pressed on by spring |
| 29 | Insert seal |
| 31 | Planet carrier clamping screws |
| 100 | Gear mechanism, more preferably with single planetary |
| | set |
| 102 | Planetary gear |
| 104 | Planetary gear |
| 106 | First limitation tooth |
| 108 | Second limitation tooth |
| 110 | Slot, more preferably lubricating slot |
| 112 | Middle of the slot |
| 114 | Middle of the gear |
| 116 | Axis gear |
| 118 | Centre of gravity gear |
| i | Transmission or transmission ratio, more preferably ring |
| | gear to sun, or operating mode |
| x | Factor in connection with the transmission ratio |

1. An engine-driven vehicle comprising:
a main drive device,
an auxiliary drive device for an auxiliary unit, wherein the main drive device couples with the auxiliary drive device and transmits power generated on the main drive device dependent on the rotational speed to the auxiliary drive device,
such that
between the auxiliary drive device and the auxiliary unit a gear mechanism shiftable without interruption in multiple stages, comprising a sun gear an inner planetary gear an outer planetary gear and a ring gear is arranged, wherein the drive takes place via the ring gear.

2. The engine-driven vehicle according to claim 1, wherein the gear mechanism steps up the transmission while maintaining the direction of rotation.

3. The engine-driven vehicle according to claim 1, wherein the gear, mechanism, comprises several operating modes of which at feast one first operating mode is an externally actuated shift.

4. The engine-driven vehicle according to claim 1, wherein a second operating mode stops the auxiliary unit.

5. The engine-driven vehicle according to claim 3 4, wherein the operating modes comprise up to three shifting stages, wherein by means of brake an operating mode (i≠1) can be switched on.

6. The engine-driven vehicle according to claim 5, wherein the 3 shifting stages comprise
a first shifting stage i=0,
a second shifting stage i=1 and
a third shifting stage i≠1,
wherein the first shifting stage brings about the stoppage, preferentially of the auxiliary unit,
the second shifting stage brings about an identical rotational speed transmission and the third shifting stage i≠1 brings about step-up transmission or step-down transmission.

7. The engine-driven vehicle according to claim 1, wherein the ring gear is driven by a pulling means.

8. The engine-driven vehicle according to claim 1, wherein the ring gear is designed as internally toothed belt pulley.

9. The engine-driven vehicle according to claim 1, wherein the gear mechanism transmits a force flow from the ring gear to the sun gear free of deflection, preferentially with the same orientation direction, more preferably in the same plane.

10. The engine-driven vehicle according to claim 1, wherein the gear mechanism transmits a moment flow from the ring gear to the sun gear free of deflection, preferentially with the same orientation direction, more, preferably in the same plane.

11. The engine-driven vehicle according to claim 1, wherein the gear mechanism comprises a substantially cylinder-shaped planet carrier, a substantially cylinder-shaped sun gear and a substantially cylinder-shaped ring gear.

12. The engine-driven vehicle according to claim 1, wherein at least one of the planetary gears of the planetary gear set comprising two planetary gears is embodied as slot-carrying planetary gear, through whose slot an oil mist is able to get to a planetary gear bearing.

13. A planetary gear set to be coupleable between an main drive device and an auxiliary device in such a kind that:
the planetary gear set is intended to transmit power of a main drive device generated in a rotational speed-dependent manner to an auxiliary drive device, wherein the gear mechanism is a gear mechanism that can be shifted without interruption in multiple stages, and the gear mechanism comprises a sun gear,
an inner planetary gear,
an outer planetary gear and
a ring gear,
and the ring gear constitutes the outer drive means via which the power from the main drive device is introduced into the auxiliary drive device tied to the sun gear.

14. The planetary gear set according to claim 13, in which on the ring gear an externally positioned running surface is present, which serves as contact or introduction surface for a drive to be fed from the main drive device.

15. The planetary gear set according to claim 13, in which the gear mechanism, steps up the transmission while maintaining the direction of rotation.

16. The planetary gear set according to claim 13, in which the gear mechanism comprises several operating modes of which at least one first operating mode is an externally actuated shift.

17. The planetary gear set according to claim 16, in which a second operating mode stops the auxiliary unit.

18. The planetary gear set according to claim 16, in which the operating modes comprise up to three shifting stages, wherein by means of brake an operating mode (i≠1) can be switched on.

19. The planetary gear set according to claim 18, in which the three shifting stages comprise
a first shifting stage i=0,
a second shifting stage i=1 and
a third shifting stage i≠1
wherein the first shifting stage brings about the stoppage preferentially of the auxiliary unit,
the second shifting stage brings about identical rotational speed transmission and the third shifting stage i≠1 brings about step-up transmission or step-down transmission.

20. The planetary gear set according to claim 13, in which the ring gear is driven by a pulling means.

21. The planetary gear set according to claim 13, in which the ring gear is designed as internally toothed belt pulley.

22. The planetary gear set according to claim 13, in which the gear mechanism, transmits a force flow from the ring gear to the sun gear free of deflection, preferentially with the same orientation direction, more preferably in the same plane.

23. The planetary gear set according to claim 13, in which the gear mechanism transmits a moment flow from the ring gear to the sun gear free of deflection, preferentially with the same orientation direction, more preferably in the same plane.

24. The planetary gear set according to claim 13, in which the gear mechanism comprises a substantially cylinder-shaped planet carrier, a substantially cylinder-shaped sun gear and a substantially cylinder-shaped ring gear.

25. The planetary gear setup according to claim 13, in which at least one of the planetary gears of the planetary gear set comprising two planetary gears is embodied as slot-carrying planetary gear through whose slot an oil mist is able to get to a planetary gear bearing.

26. The planetary gear set according to claim 13, in which a shifting device is embodied as braking device, more preferably electromagnetic braking device, which consists of at least two braking elements and shifts between the operating modes (i=0, i=1, i≠1) through braking.
